(19) United States
(12) Patent Application Publication
(10) Pub. No.: US 2013/0157572 A1
(43) Pub. Date: Jun. 20, 2013

(54) METHOD AND SYSTEM FOR TRANSFERRING AN IMAGE BETWEEN TWO MOBILE TELEPHONE DEVICES

(71) Applicant: Sylvain Gommier, Cergy Pontoise (FR)

(72) Inventor: Sylvain Gommier, Cergy Pontoise (FR)

(73) Assignee: OPTION, Leuven (BE)

(21) Appl. No.: 13/579,101

(22) PCT Filed: Feb. 15, 2011
(86) PCT No.: PCT/EP2011/052238

§ 371 Date: Feb. 21, 2013

(30) Foreign Application Priority Data
Feb. 15, 2010 (FR) 10/51013

(51) Int. Cl. H04B 7/00

(52) U.S. Cl. CPC H04B 7/00
USPC 455/41.2

(57) ABSTRACT

The present invention relates to a method of transferring an image of a mobile telephony device named transmitter (T) to another mobile telephony device named receiver (R), the method comprising of step (1) for the preparation of the transfer in which the user selects an image (P) stored in a memory of the transmitter (T), a receiver (R) is selected after a searching phase and a radio frequency communication is established between the transmitter and the receiver, step (3) of validation of this transfer by the user and step (2) of effective transfer of the selected image (P) in which begins the effective transfer of the image. The method is characterized in that the said step (2) of effective transfer of the selected image (P) follows step (1) of preparation of the transfer of this image (P) and is prior to step (3) of validation of the transfer by the user.

The present invention also relates to an image transfer system, a mobile telephony device and a computer program.

The present invention relates to a method and a system for transferring an image from a mobile telephony device named transmitter to another mobile telephony device named receiver.

Methods for transferring an image between two mobile telephony devices are known. These methods include a step of preparation of the transfer, a step of validation of this transfer by the user and a step of effective transfer of the image.

During the preparation step of the transfer, from the transmitter side, an image is selected by the user and the transmitter launches a searching phase for mobile telephony devices within its reach. For this, it is common that the transmitter emits a specific frame of a radio frequency signal to which every mobile telephony device that receives this frame responds. The transmitter then establishes a list of devices that responded to the transmission of this specific frame and offers the user to select the receiving device from this list. Once done, the transmitter and the selected receiver establish a radio frequency communication between them to transfer the image.

Once the transfer is prepared, the user validates the effective transfer of the image and the actual transfer of the image is performed. An indication displayed on the screen of the emitting device may then inform the user of the progress of the effective transfer of the image to the receiving device.

The actual period of the transfer of an image by radio frequency path is generally quite long because of the amount of data to be transferred and available bandwidth at time of transfer is often very low.

Users very often get then impatient while watching the indication of effective transfer that is displayed on the screen of their device and often cancel a transfer in progress. Therefore, these same users use this type of transfer very little because they find this way of image transfer too laborious.

The problem, solved by this invention, is to transfer an image between two mobile telephony devices in a way that gives the user the illusion that the effective transfer of the image between these devices is fast.

To this end, the present invention relates to a method of transferring an image from a mobile telephony device named transmitter to another mobile telephony device named receiver, the method comprising a step of preparation of the transfer during which the user selects an image stored in the memory of the transmitter, a receiver is selected following a searching phase and a radio frequency communication is established between the transmitter and the receiver, a step of validation of the transfer by the user and a step of effective transfer of the selected image during which the effective transfer of the image begins. The method is characterized in that the said step of effective transfer of the selected image follows the step of preparation of the image transfer and is prior to the step of validation of the transfer by the user.

Thus, the effective transfer of the image begins when a communication is established between the two devices instead of the methods of the prior art that are waiting for the user to validate this transfer through a graphical interface to start this effective transfer.

The time taken to present to the user the request for validation of the transfer added to that of user reflection before deciding to validate the transfer of the image, thus, is used, according to the present invention to effectively transfer the selected image. The method can thus give the user the illusion that the transfer is fast compared to the methods of the prior art by the fact that the launch of the transfer of the image is systematic in contrast to that of the methods of the prior art.

In another aspect, during the step of validation of the transfer by the user, a command is transmitted by the transmitter to the receiver, the said command triggering, on one hand, the execution of instructions of a first program resident in a memory of the transmitter and, on the other hand, synchronously executing the instructions of a second program resident in a memory of the receiver, the said instructions defining an animation that is displayed on the screen of the transmitter and on the screen of the receiver synchronously.

Sending such a command allows an attractive animation to be played simultaneously on the screens of both devices. This short animation amplifies the illusion that the effective transfer of the image is very fast.

According to one embodiment, the instructions of the first and second programs define an animation that comprises displaying the selected image on the screen of the transmitter, then making the display of the image on this screen disappear, gradually and according to a determined direction, and progressively displaying, gradually and according to the said determined direction, on the screen of the receiver, the parts of the selected image that are no longer displayed on the screen of the transmitter.

According to one embodiment, the direction is determined by the relative geographical position of the transmitter and the receiver.

According to one embodiment, the relative geographical position is obtained by updating an initial position determined by pairing the transmitter and the receiver.

According to one embodiment, updating the initial position is based on the measures taken by the receiver, measures being sent periodically to the transmitter.

According to one embodiment, the user validates the transfer of the image selected by a sliding touch on the screen of the transmitter, then tactile.

According to one embodiment, the display of the transmitter includes an indication of a direction in which the user must perform the sliding action to validate the transfer of the selected image.

In another aspect, the present invention provides a system for transferring an image from a mobile telephony device named transmitter to another mobile telephony device named receiver, the transmitter comprising a memory for storing at least one image, means for preparing the transfer of an image, means for validating the transfer of an image, and means for effectively performing the transfer of an image. The system is characterized in that the transmitter comprises means for triggering the beginning of the effective transfer of an image following the preparation of the transfer of this image and prior to the validation of this transfer by the user.

According to another aspect of the system, the transmitter comprises a screen, preferably tactile, a memory that stores the instructions of a first program, the receiver comprises a memory that stores the instructions of a second program, and the transmitter is provided for transmitting a command to the receiver, the said control triggering on one hand, the execution of the instructions of the first program and on the other hand, synchronously the execution of the instructions of the second program, the said instructions of the first and second programs defining an animation that is displayed on the screen of the transmitter and on the screen of the receiver synchronously.

In another aspect, this invention relates to a mobile telephony device having means to implement telephony functionality and a tactile screen. The device is characterized in that it comprises the means of the transmitter and the means of the receiver of a system above.

In another aspect, the present invention concerns a computer program stored on an information support medium, characterized in that it contains instructions for implementing a process as above, when loaded and performed by a mobile telephony device as above.

The aspects of the invention mentioned above, as well as others, will become more apparent upon reading the following description of an exemplary embodiment, the said description being given in connection with the joint drawings, among which:

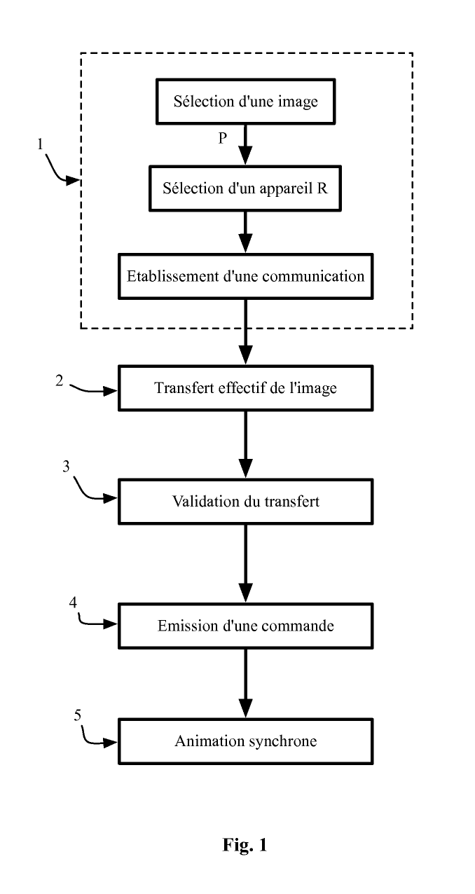

FIG. 1 shows a diagram of the process steps of transferring an image of a mobile telephony device transmitter E to another mobile telephony device receiver R.

The process starts with a step 1 of preparation of the transfer. During this step 1, the user selects an image P stored in a memory of the device E. During this step 1, a mobile telephony device R is selected following a searching phase similar to that described in the introduction. For this, the device E collects the responses received following the transmission of a specific frame as described in the introduction, and provides a list of devices for the user.

According to one embodiment, the response sent by a device has a specific identifier that defines, for example, a range of particular mobile telephony devices, and the list of devices within reach is then filtered to only keep from this list the devices of which the answers have this specific identifier.

The user selects then a telephony device R from this list of devices, optionally filtered, and a radio frequency communication is established between devices E and R, with which the step of preparation of the transfer ends.

The method comprises a step 2 of effective transfer of the image P in which the effective transfer of this image begins. According to the present invention, this step 2 follows the step of preparation of the transfer of the image P and is prior to a step 3 of validation of this transfer by the user.

Thus, the effective transfer of the image P begins after the preparation of the transfer of the image and prior to the validation of this transfer by the user. According to one alternative, during step 2, an indication I1 is displayed on the screen of the device E. This indication informs the user that the transfer is being prepared. This indication may, for example, be in the form of a page showing the image P, a visual indicator showing the progress of the preparation of the transfer and/or a flashing indicator or of a particular colour during the preparation of the transfer. This indicator remains fixed or changes colour when the preparation of the transfer is complete.

This alternative allows the user to wait for the duration of the effective transfer of the underlying image P but the indications on the indication I1 refer to the preparation of the transfer of the image P and not to the effective transfer of this image. The user will have less incentive to cancel this preparation of the current transfer, whereas he/she is much more inclined to do so if the indication was informing the user of the actual evolution of the transfer.

According to one embodiment, the duration of the indication display I1 is determined so that the image P is effectively transferred in its entirety at the end of step 2. For these purposes, the amount of data to be transferred is limited to a maximum size (e.g. 8 Mb) defined according to the bandwidth of the established communication between device E and device R.

According to another aspect, step 2 is followed by a step 3 of validation of the transfer by the user during which a command C is transmitted by the device E to the device R. The command C triggers the execution of the instructions of a program P1 resident in the memory of the device E and synchronously triggers the execution of the instructions of a program P2 resident in the memory of device R.

Instructions of programs P1 and P2 define an animation that is displayed on the screen of the device E and on the screen of device R. The animation can represent the image transfer and the display of the animation on the screen of the device E is synchronized with the display of this animation on the screen of the device R.

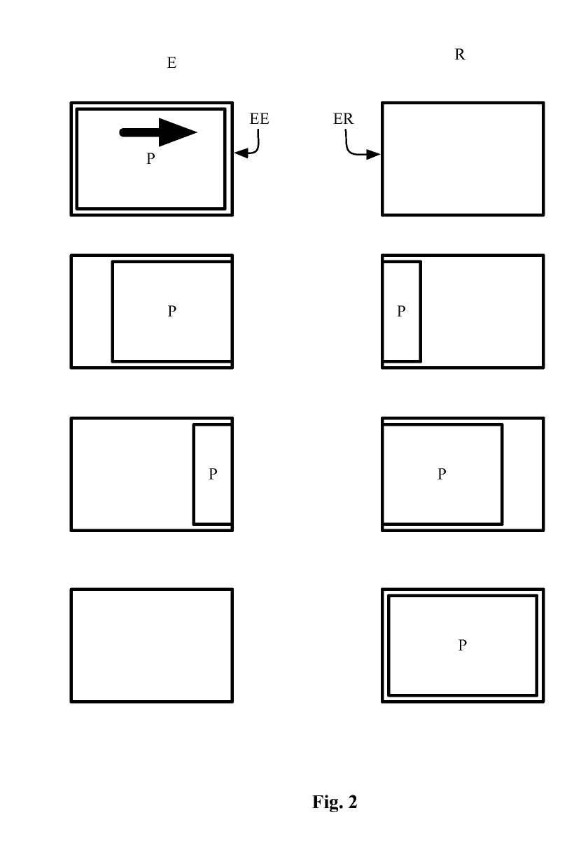

FIG. 2 is an illustration of an embodiment of programs P1 and P2 that define an example of such an animation.

According to this embodiment, the instructions of programs P1 and P2 define an animation that consists of displaying the selected image P on the screen EE of the device E. No image is, therefore, displayed on the screen ER of the device R. The animation then makes the display of the image on the screen EE disappear, gradually and according to a determined direction, and progressively displays, gradually and according to the said predetermined direction, on the screen ER, the parts of the image P that are no longer displayed on the screen EE. Such animation is possible because the image P is therefore already transferred to the device R.

The two progressions are synchronous with one another because the synchronization triggers programs P1 and P2. At the end of this animation, the image P is fully displayed on the screen ER while no image is displayed on the screen EE.

According to one embodiment, the direction is determined by the relative geographical position of the transmitting device and receiving device.

According to one embodiment, the relative geographical position is obtained by updating an initial position determined by the pairing of device E and device R. Typically, this pairing is performed by placing both devices E and R on each other.

According to one embodiment, updating the initial position is based on measures taken by the receiving device, measures being sent periodically to the transmitting device.

Indeed, by equipping the receiving device with a means to determine its movement such as an accelerometer and a means for determining the direction of this movement, such as a compass, the device R takes measurements and can transmit to the device T, either these measures or a direction of travel determined from these measures (if there is a travel). Thus, from a common initial position, created by pairing the two devices E and R, the device E can determine in which direction the device R moved (or moves) from its initial position and thereby estimate the geographical position of the device R with respect to its own, which may be identical to the starting position but which may also have changed. In this case, the current position of the device E can also be estimated by taking measures. Thus, when the device E must determine the direction in which the image P must disappear from the screen EE, the device E determines a direction from measures or the direction it received from the device R (and optionally any measures it took itself). This direction, represented by an arrow to the right with a thick line on the example of FIG. 2, corresponds to a straight line virtually connecting the devices E and R. This determined direction is then transmitted to the device R which uses it then to make appearing on its screen ER parts of the image P that are no longer displayed on the screen EE according to this direction (in the example of FIG. 2, the progressive display of the image is done from the left). The device E also communicates to the device R the indications that define the parts of the image that are no longer displayed on the screen EE. These indications can be ranges of numbers that indicate the rows and columns of the image P which are no longer displayed or conversely the rows and columns of image P that are still displayed. These indications are obviously exchanged periodically so that the animation displays remain synchronised between the two screens EE and ER.

According to one embodiment, the user validates the transfer of the image P by a touch sliding down on the screen EE, then tactile.

According to one embodiment, the screen EE displays an indication of a direction in which the user must perform the sliding action to validate the transfer of the image. This indication may be for example an arrow and the touching/sliding action then consists of pressing the screen, for example, with the user's finger and sliding the finger in the indicated direction.

According to one aspect, the present invention relates to a system S to transfer an image from on mobile telephony device named transmitter E to another mobile telephony device named receiver R. This system S is provided for implementing the method steps described in connection with FIGS. 1 and 2.

The transmitter E comprises a memory M for storing at least one image. It also comprises means for preparing the transfer of a stored image to the receiver R. These means include means for selecting an image P stored in the memory M, means for initiating a searching phase of telephony devices within its reach, means for selecting a receiver R from a list of mobile telephony devices obtained at the end of the searching phase, and means for establishing a radio frequency communication with the receiver R.

According to one embodiment, the transmitter E comprises means for extracting, from a response transmitted by a mobile telephony device during a searching phase, a specific identifier and means for forming a list containing only the devices within its reach to which the response includes the specific identifier.

The transmitter E also comprises means to validate the transfer of an image, means to actually achieve the transfer of an image, and means to trigger the start of the effective transfer of an image following the preparation of the transfer of this image and prior to the validation of this transfer by the user.

According to another aspect, the transmitter includes a memory that stores the instructions of the program P1. The receiver R comprises a memory which stores the instructions of the second program P2, and the transmitter E is provided for transmitting a command C to the receiver R, the said command C triggering, on one hand, the execution of the instructions of the program P1 and on the other hand, synchronously the execution of the instructions of the program P2.

The transmitter E comprises means for determining its geographical position, that of the receiver R and a direction in which the receiver R is from its relative position with the receiver R.

The transmitter E also comprises means for forming an indication I1, to obtain an image or part of an image, and for executing an animation defined by the instructions of programs P1 and P2.

It finally has a screen, preferably tactile EC, provided for displaying an indication I1, an image or part of an image, a direction in which the receiver R is and the animation when it is executed.

The receiver R comprises also means for forming and transmitting a response during the searching phase. It further comprises means for executing the instructions of program P2 so that the display of the animation on the screen of the transmitter E is synchronized with the display of the animation on the screen of the receiver R.

A mobile telephony device that can be sometimes the transmitter T, sometimes the transmitter R, includes both the means of the transmitter E and those of the transmitter R.

The means of the transmitter E and the receiver R can be either implemented by a dedicated set of electronic components involving, inter alia, a memory, a processor and optionally one or more logical functions. These means may also be present in the form of instructions of a computer program Pr defined to implement the steps of a method described in connection with FIGS. 1 and 2, those instructions being stored in a memory and executed by a processor.

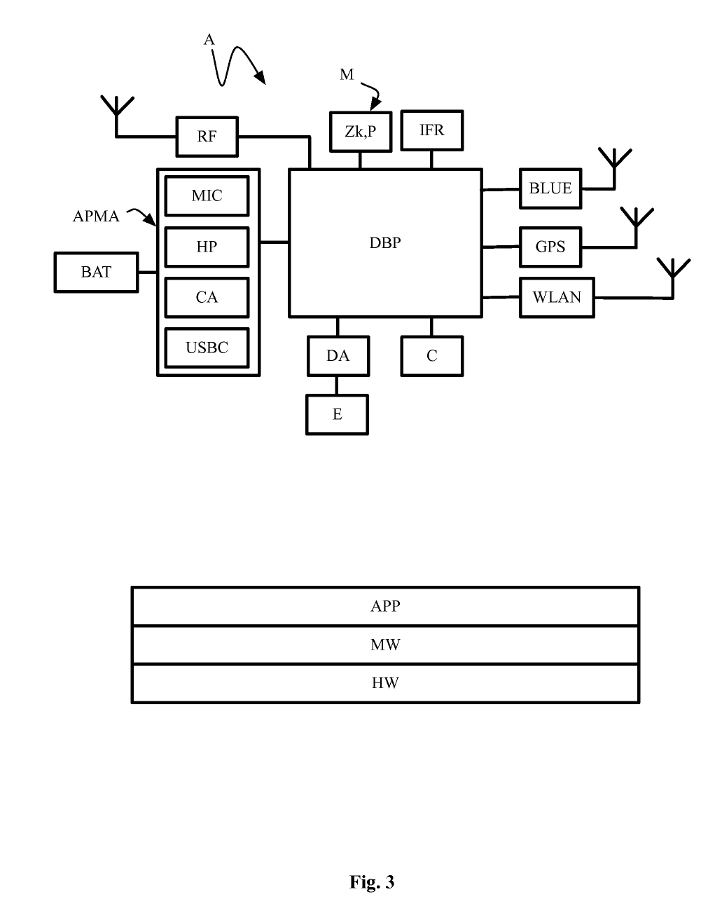

FIG. 3 shows a diagram of an embodiment of an architecture of a mobile telephony device. This device A comprises a set of electronic components that form a layer HW (hardware) represented in the upper part of FIG. 3, and a stack SW (software layer) of protocol layers that allow the implementation of the functions performed by the apparatus A and software applications implemented on this device A (shown in the lower part of FIG. 4).

At the layer HW, the device A includes a processor DBP, memory modules M, for example such as SDRAM. This memory stores at least one image, the instructions of the programs P1, P2 and Pr. The device A further comprises at least one means of radio frequency communication such as for example a RF module that handles communications such as GSM, GPRS and/or EDGE, a BLUE module that handles Bluetooth communications, a GPS module for satellite communications and/or a WLAN module for wireless communication and a IRF means that handles infrared type communications. Each module is connected to an antenna. This list is not limitative and is given here as way of example. The device A also includes an APMA module to manage analog data, power and audio signals transmitted between the device A and periphery devices connected by a wire to device A. This APMA module provides, for this purpose, features that are here schematically grouped into five modules: ICM module provided for signals exchanges with a microphone, a HP module provided for signals exchanges with a loudspeaker, a CA module provided for signals exchanges with Hi-Fi headphones, a USBC module provided for signals exchanges from a USB cable. Again, this list is not limitative and is given here as way of example. These communication means are used during the searching phase and for the transmission/reception of the command C, the geographical position of the device and the indications relating to the image parts.

The device A also includes a tactile screen EC and means DA for the detection of a touch and a sliding touch of a user on this screen. Thus, as soon as a user touches the screen and slides his/her finger across the screen in the direction of the receiver R, the means DA inform the processor DBP which then implements the instructions of program Pr stored in the memory M. The device A can also optionally comprise a camera C in communication with the processor DBP. It also comprises a battery BAT connected to the APMA module so that the module assures its management (level, functioning default, . . . ).

The stack SW implements an operating system that allows for interaction with various modules and electronic components of the HW layer, which communicates with other protocol layers MW of higher level called middleware. The features of device A and software applications are then implemented by an APP applicative layer based on middleware level layers.

Other architectures can be used to implement the method described in relation to FIG. 1 without departing from the scope of the present invention as long as the elements of the device A, whether from the layer HW or a layer of the stack SW, are provided for storing the instructions of the computer program Pr.

1. A method for transferring an image of a mobile telephony device named transmitter (T) to another mobile telephony device named receiver (R), the method comprising of step (1) for the preparation of the transfer in which the user selects an image (P) stored in a memory of the transmitter (T), a receiver (R) is selected after a searching phase and a radio frequency communication is established between the transmitter and the receiver, step (3) of validation of this transfer by the user and step (2) of effective transfer of the selected image (P) in which the effective transfer of the image begins,
characterized in that the said step (2) of effective transfer of the selected image (P) follows step (1) of preparation of the transfer of this image (P) and is prior to step (3) of validation of the transfer by the user.

2. The method according to claim 1, wherein during the step of validation of the transfer by the user, a command (C) is transmitted by the transmitter to the receiver, the said command triggering on one hand, the execution of the instructions of a first program (P1) resident in a memory of the transmitter and, on the other hand, synchronously the execution of the instructions of a second program (P2) resident in a memory of the receiver, the said instructions defining an animation that is displayed on the screen of the transmitter and on the screen of the receiver, synchronously.

3. The method according to claim 2, wherein the instructions of first and second programs (P1, P2) define an animation that consists in displaying the selected image (P) on the screen (EE) of the transmitter (T), then making the image displayed on this screen (EE) disappear, gradually and according to a determined direction, and progressively displaying, gradually and according to the said given direction, on the screen (ER) of the receiver (R) the parts of the selected image (P) which are no longer displayed on the screen (EE) of the transmitter (T).

4. The method according to claim 3, wherein the direction is determined by the relative geographical position of the transmitter (T) and the receiver (R).

5. The method according to claim 4, wherein the relative geographical position is obtained by updating an initial position determined by pairing the transmitter (T) and receiver (R).

6. The method according to claim 5, wherein the update of the initial position depends on the measures taken by the receiver, measures being sent periodically to the transmitter.

7. Method according to one of the preceding claims claim 1, wherein the user validates the transfer of the selected image (P) by a sliding touch on the screen (EE) of the transmitter (T), then tactile.

8. The method according to claim 7, wherein the screen (EE) of the transmitter (T) displays an indication of a direction in which the user must perform the sliding action to validate the transfer of the image selected (P).

9. A system for transferring an image from a mobile telephony device named transmitter (T) to another mobile telephony device named receiver (R), the transmitter (T) having
a memory (M) for storing at least one image.
means for preparing the transfer of an image,
means for validating the transfer of an image, and
means for actually achieving the transfer of an image,
characterized in that the transmitter (T) comprises means for triggering the beginning of the effective transfer of an image following the preparation of the transfer of this image and prior to the validation of this transfer by the user.

10. The system according to claim 9, wherein
the transmitter (T) comprises a screen (T), preferably tactile and a memory (M) which stores the instructions of a first program (P1),
the receiver (R) comprises a memory (M) which stores the instructions of a second program (P2), and
the transmitter (T) is provided for emitting a command (C) to the receiver (R), the said command (C) triggering, on the one hand, the execution of the instructions of the first program (P1) and, on the other hand, synchronously the instructions of the instructions of the second program (P2), the said instructions of the first and second programs defining an animation that is displayed on the screen of the transmitter (T) and on the screen of the receiver (R) synchronously.

11. A mobile telephony device comprising means for implementing telephony functionalities and a tactile screen, characterized in that it comprises the means of the transmitter (T) and/or the means of the receiver (R) of a system according to claim 9.

12. A computer program (Pr) stored on an information carrier, characterized in that it comprises instructions for implementing the method according to claim 1, when loaded and executed by a device according to claim 11.
